(19) United States
(12) Patent Application Publication
(10) Pub. No.: US 2024/0076961 A1
(43) Pub. Date: Mar. 7, 2024

(54) METHOD OF GEOTHERMAL DRIVEN CO2 CATALYTIC REDUCTION FOR ENHANCING CO2 SEQUESTRATION AND OIL RECOVERY

(71) Applicant: CHINA UNIVERSITY OF PETROLEUM-BEIJING, Beijing (CN)

(72) Inventors: Rukuan CHAI, Beijing (CN); Yuetian LIU, Beijing (CN); Wenkuan ZHENG, Beijing (CN); Jingpeng LI, Beijing (CN); Liang XUE, Beijing (CN); Jingru WANG, Beijing (CN); Yuting HE, Beijing (CN)

(73) Assignee: CHINA UNIVERSITY OF PETROLEUM-BEIJING, Beijing (CN)

(21) Appl. No.: 17/985,860

(22) Filed: Nov. 13, 2022

(30) Foreign Application Priority Data
Sep. 2, 2022 (CN) 202211070730.X

(51) Int. Cl. E21B 41/00; B01D 53/62; B01D 53/90; B01J 23/825; B01J 23/835; E21B 43/114; E21B 43/16; E21B 43/38

(52) U.S. Cl. CPC E21B 41/0064; B01D 53/62; B01D 53/90; B01J 23/825; B01J 23/835; E21B 43/114; E21B 43/164; E21B 43/38; B01D 2221/04; B01D 2257/504; B01J 2523/17

(57) ABSTRACT

The present invention provides a mixed injection fluid and a corresponding method for enhancing CO₂ sequestration and oil recovery, which is a method of the geothermal driven CO₂ catalytic reduction for enhancing CO₂ sequestration and oil recovery. In the present invention, a technical solution of the liquid nitrogen fracturing, an injection fluid injection, and the catalysis transportation and storage were adopted, which makes full use of the thermal energy of deep geothermal reservoir in combination with nano-Cu-based catalysts to activate the hydrothermal cracking reaction of crude oil and CO₂ thermal reduction reaction, so to simultaneously enhance crude oil recovery and CO₂ sequestration, fundamentally solving the existing problems of CO₂-EOR technologies. Moreover, CO₂ thermal catalytic reduction products can also work as a surfactant to accelerate the desorption crude oil from the rock surface and decrease the interfacial tension, and finally EOR.

The application claims the priority to Chinese Patent Application No. 202211070730.X, titled “METHOD OF GEOTHERMAL DRIVEN CO₂ CATALYTIC REDUCTION FOR ENHANCING CO₂ SEQUESTRATION AND OIL RECOVERY”, filed on Sep. 2, 2022 with the China National Intellectual Property Administration, which is incorporated herein by reference in entirety.

### FIELD

The present disclosure belongs to the field of carbon capture, utilisation and storage (CCUS), and relates to an injection fluid and a method for enhancing CO₂ sequestration and oil recovery, in particular to a method of geothermal driven CO₂ catalytic reduction for enhancing CO₂ sequestration and oil recovery.

### BACKGROUND

As the greenhouse effect aggravates, CO₂ emission reduction has become a consensus of mankind. Upholding the firm belief of “building a community with a shared future for mankind”, China has continued to make efforts in the field of carbon neutrality, and officially entered the journey of CO₂ emission reduction. How to achieve CO₂ emission reduction economically and efficiently was an important issue confronted by all walks of life. It is critical to control CO₂ emissions at the source, meanwhile the CO₂ sequestration technologies also deserved wide attention because there are always some irreducible carbon that produced in industry, agriculture, and etc. According to the research of “China's ‘carbon neutrality’ framework roadmap”, it is estimated that by 2060, deducting the passive carbon sequestration amount, i.e., the ecology and oceans absorption sequestration, there will still be as much as 2.5 billion tons of irreducible CO₂ that need to be processed through the industrial sequestration technologies. Therefore, CO₂ sequestration technology will play an extremely important role in the entire strategy of carbon emission peak and carbon neutrality.

CO₂-Enhanced Oil Recovery (EOR) has become the most feasible CO₂ sequestration technology due to its unique advantages of the large sequestration amount and high economic benefits from gas-to-oil exchange. However, the common CO₂-EOR technologies (such as CO₂ immiscible flooding, CO₂ miscible flooding and carbonated water flooding) were implemented by injecting CO₂ into the reservoir to displace crude oil and simultaneously sequestration itself. Some problems have been found in the engineering application, including: CO₂ channeling leads to the bad crude oil displacement, low CO₂ sequestration efficiency and stability; CO₂ extracts light components of crude oil and causes severe asphaltene precipitation, eventually blocks the flow path and damages the reservoir; CO₂ is produced with crude oil, for which only a small part of the CO₂ is sequestrated, and it is difficult to achieve large-scale sequestration of CO₂; abnormal pressure increase during CO₂ injection and sequestration causes secondary geological disasters. To sum up, it is of great significance to optimize the existing CO₂-EOR technologies for successfully implementing the China's carbon emission peak and carbon neutrality strategy.

Therefore, the academic and industrial communities have carried out continuous research on CO₂-EOR technologies, and proposed some solutions. For example, patent 201810104415.1 discloses a method for developing tight oil through nitrogen-assisted CO₂ huffing-puffing; patent 201310216598.3 discloses a technology for achieving maximum sequestration and residual oil displacement by injecting excessive supercritical CO₂; patent 201710204187.0 discloses a supercritical CO₂ huffing-puffing method for tight oil reservoir development; patent 201810237470.8 discloses a CO₂ miscible displacement method for developing a high saturation-pressure oil reservoir; patent 201810273382.3 discloses a CO₂ injection method and system for improving the crude oil recovery; patent 201610913445.8 discloses a CO₂ and N₂ mixed displacement method for low-permeability oil reservoir development; patent 201880010439.9 discloses a method and a system for CO₂ enhanced oil recovery, and so on. However, in the above technical solutions, the CO₂ channeling was always serious. Furthermore, the prior art also discloses some technical solutions for preventing CO₂ channeling. For example, patent 201410315718.X discloses a two-stage channeling blocking method for suppressing CO₂ channeling in a low-permeability fractured reservoir development; patent 202110268970.X discloses a channeling blocking system and method for CO₂ immiscible flooding in a low-permeability reservoir; patent 201310297000.8 proposes a channeling blocking agent for CO₂ flooding in high-temperature and low-permeability oil reservoir; patent 201610369094.9 discloses a method for controlling CO₂ channeling of by utilizing a CO₂ response surfactant; patent 202111304265.7 discloses a multi-scale system for controlling CO₂ channeling in tight oil reservoir and a preparation method thereof, and so on. Although in the above technical solutions, a series of CO₂ channeling-blocking agents have been developed, which can inhibit CO₂ channeling to a certain extent, there are also problems such as the increased engineering difficulty for CO₂ injection; the increased reagent costs; and the increased risk of the secondary geological disaster.

Therefore, create a novel CO₂-EOR technology to further solve the above-mentioned technical problems has become one of the focuses of many researchers.

### SUMMARY

Regarding this, the technical problem to be solved by the present invention is to provide a mixed injection fluid and a method for enhancing CO₂ sequestration and oil recovery, in particular a method of the geothermal driven CO₂ catalytic reduction for enhancing CO₂ sequestration and oil recovery. The injection fluid and the corresponding method provided by the present invention make full use of the thermal energy of the deep geothermal reservoir in combination with nano-Cu-based catalyst to activate the hydrothermal cracking reaction of crude oil and thermal reduction reaction of CO₂, so as to simultaneously enhance crude oil recovery and CO₂ sequestration capacity, stability and efficiency, fundamentally solving the existing problems of the current CO₂-EOR technologies.

The present invention provides a mixed injection fluid, which, in parts by weight, comprises:

| | | |
|---|---|---|
| crude oil | 100 | parts by weight; |
| water | 8.0 to 12.0 | parts by weight; |
| proppant | 5.0 to 20.0 | parts by weight; |
| nano-Cu-based catalyst | 0.01 to 0.05 | parts by weight. |

Preferably, the crude oil is high-viscosity and rich in asphaltene and resin;
the viscosity of the crude oil is 50 to 150 mP·s;
the content of the asphaltene is 8% to 25%;
the content of the resin is greater than 15%.

Preferably, the proppant comprises one or more of quartz sand, bauxite and ceramsite;
the nano-Cu-based catalyst comprises a copper catalyst and/or a copper alloy catalyst;
the mixed injection fluid enters the fractured fracture in the state of water-in-oil as the basic liquid carrying proppant and nano-Cu-based catalyst;
the mixed injection fluid is injected into the deep geothermal reservoir. Herein, the nano-Cu-based catalyst adheres to the porous petroleum coke carrier formed by the hydrothermal cracking of the crude oil.

The present invention further provides a method for enhancing CO₂ sequestration and oil recovery, comprising the following steps:
1) arranging an injection well and a transfer well around a production well; wherein, the injection well is an injection well that is drilled through the crude oil reservoir to reach the deep geothermal reservoir, and the transfer well is a transfer well that is drilled through the crude oil reservoir to reach the deep geothermal reservoir;
wherein the perforation of the injection well in the deep geothermal reservoir is in an open state;
wherein the perforation of the transfer well in the deep geothermal reservoir is in an open state;
2) using high pressure liquid nitrogen to fracture the deep geothermal reservoir between the injection well and the transfer well;
3) injecting the mixed injection fluid into the injection well until the production of the transfer well is equal to the injection, then stopping the injection, and placing packers in the injection well and the transfer well respectively to perform well soaking;
4) removing the packers, injecting CO₂ into the deep geothermal reservoir through the injection well to displace light crude oil components that produced by hydrothermal cracking of crude oil in the geothermal reservoir, producing the light crude oil components through the transfer well until the light crude oil components are no longer produced, and stopping the CO₂ injection;
5) opening the perforation of the transfer well at the crude oil reservoir, then placing a cylinder containing nano-Cu-based catalyst and porous nano-catalyst carrier into the wellbore of the transfer well between the crude oil reservoir and the deep geothermal reservoir, and then placing a wellbore packer in the wellbore of the transfer well above the crude oil reservoir;
6) injecting the mixture of H₂O and CO₂ into the deep geothermal reservoir through the injection well to activate CO₂ thermal reduction reaction; the water steam, CO₂ and CO₂ thermal reduction products flowing through the cylinder containing the catalysts in the transfer wellbore, in which process the unreacted CO₂ being continuously reduced; and subsequently, the water steam, CO₂, CO₂ thermal reduction products and nano-Cu-based catalyst entering the crude oil reservoir to activate the hydrothermal cracking reaction of crude oil and thermal reduction reaction of CO₂.

Preferably, the production well is drilled through and perforates the crude oil reservoir;
the number of the production well can be one, two or more;
the number of the injection well is one.

Preferably, the number of the transfer well is one or more;
the deep geothermal reservoir is a deep geothermal reservoir comprising hot dry rock;
the duration of the well soaking is 20 to 30 days.

Preferably, the cylinder is a cylinder without a top cover and with a porous bottom;
the outer wall of the cylinder is wrapped with a high temperature resistant sealing ring;

a porous fixing device is arranged inside the cylinder;
the porous nano-catalyst carrier compounded with the nano-Cu-based catalyst is dispersed and fixed on the porous fixing device.

Preferably, the mass ratio of the nano-Cu-based catalyst to the porous nano-catalyst carrier is 1:(10 to 20);
above the crude oil reservoir is specifically a position above the crude oil reservoir close to the crude oil reservoir;
in the mixture of H₂O and CO₂, the volume ratio of H₂O to CO₂ is 1:(2.5 to 4), and the volume ratio is the volume ratio under formation pressure and temperature.

Preferably, the injection of the mixture of H₂O and CO₂ is specifically continuous injection during the oil recovery enhancement process;
the products of CO₂ thermal reduction reaction comprise small organic molecules;
the small organic molecules comprise one or more of methane, methanol and formic acid.

Preferably, the method further comprises the following steps:
7) when the crude oil production decreases to a certain extent, plugging the perforation of the transfer well in the crude oil reservoir, and perforating the crude oil reservoir in the injection well, and continuing reverse displacement by using the mixture of H₂O and CO₂.

The present invention provides a mixed injection fluid and a corresponding method for enhancing CO₂ sequestration and oil recovery using the injection fluid. Compared with the prior art, the present invention investigates the aforementioned existing CO₂-EOR technologies, and considers that in the above-mentioned technical solutions where CO₂ is injected into the crude oil reservoir as a fluid medium in an immiscible, miscible or supercritical phase to displace crude oil, the main problems are as follows: (1) the geological structure of crude oil reservoir is complex, with the prominent heterogeneity and anisotropy, in which CO₂ channeling is almost inevitable when CO₂ is injected, which greatly reduces the efficiency of crude oil displacement; (2) CO₂ extracts light components of crude oil and causes severe asphaltene precipitation, which eventually blocks the flow path, weakens fluid seepage capacity, and further enhances the heterogeneity and anisotropy of the crude oil reservoir; (3) CO₂ is produced together with crude oil, for which only a small part of the CO₂ is successfully sequestrated, and it is difficult to achieve large-scale CO₂ sequestration; (4) even if a small amount of CO₂ is sequestrated, the inherent heterogeneity and anisotropy superimposed with the activity of CO₂ itself are easy to cause CO₂ leakage and re-pollute the environment. Although the above-mentioned corresponding anti-channeling technical solutions, using a series of CO₂ channeling blocking agents, can inhibit CO₂ gas channeling and enhance oil recovery, these technologies have not solved the inherent problems of the CO₂-EOR technologies: only EOR effect is focused, CO₂ and crude oil are extracted simultaneously, only a small amount of CO₂ can be sequestrated, so it is difficult to achieve large-scale sequestration of CO₂; and compared with other CO₂ sequestration technologies, the CO₂-EOR technology is advantageous for its low-cost, economical and efficient. Although the injection of various complex channeling blocking agents can improve the performances of the current CO₂-EOR technologies, the increase in cost caused by the channeling blocking agent itself and the increase in the difficulty of industrial implementation largely reduce the application potential of these CO₂-EOR technologies.

Based on the above research on the prior art, the present invention believes that: (1) in the current CO₂-EOR technologies, only the EOR effect is focused, while the CO₂ sequestration performance is neglected. In most of the current CO₂-EOR technologies, CO₂ is used to displace crude oil in a miscible, immiscible or supercritical phase, and is extracted together with crude oil. In this process, the sequestration amount of CO₂ is small and the sequestration efficiency is quite low; (2) in the process of CO₂-EOR, due to the inherent heterogeneity and anisotropy of the crude oil reservoir, the injected CO₂ is prone to channeling along the preferential percolation path such as fractures and high-permeability strips, which remarkably reduces the oil displacement efficiency and swept volume, resulting in bad CO₂-EOR performance; (3) in the process of CO₂-EOR, CO₂ extracts light components of crude oil, causing asphaltene precipitation, blocking percolation path, and seriously damaging the reservoir; (4) CO₂ sequestrated in complex oil reservoir is easily affected by the heterogeneity and anisotropy of the reservoir superimposed with man-made and natural effects, so as to cause CO₂ leakage and re-pollution of the environment; (5) CO₂ sequestrated in complex oil reservoir causes abnormal pressure augment, thereby causing the secondary geological disasters.

Based on the above research, the present invention specially designs a mixed injection fluid with a specific composition and content and a corresponding method for enhancing CO₂ sequestration and oil recovery, which is a method of the geothermal driven CO₂ catalytic reduction for enhancing CO₂ sequestration and oil recovery. In the present invention, a technical solution of liquid nitrogen fracturing in combination with injecting a mixed fluid is adopted. Since the temperature of deep geothermal reservoir, especially hot dry rock, is generally higher than 200° C., such a high temperature has severe damage to drill unit, and conventional fracturing fluid and sand-carrying fluid are so easy to vaporize hence they cannot work normally. The temperature of liquid nitrogen is as low as −196° C. to −210° C., and the use of liquid nitrogen fracturing can effectively reduce the damage of ultra-high temperature to the drill unit. The most important thing is that liquid nitrogen can quickly cool the formation within a period of time, providing conditions for subsequent fluid injection, and avoiding immediate vaporization. A mixed injection fluid with a specific formulation of a mixture of crude oil and water, nano-Cu-based catalyst carried with proppant is injected into the deep geothermal reservoir (comprising hot dry rock). This is because the boiling point of crude oil is much higher than that of aqueous solution, with the assistant of the cooling effect of liquid nitrogen, water-in-oil as the basic liquid can effectively carry proppant and nano-Cu-based catalyst into the fractured fracture. As the cooling effect of liquid nitrogen gradually decreases, the high temperature in deep geothermal reservoir (comprising hot dry rock) accelerates the dissociation of H₂O. The crude oil is combined with H⁺ generated by the dissociation of H₂O, catalyzed by nano-Cu-based catalyst, and undergo hydrothermal cracking reaction to generate light crude oil and petroleum coke. During this process, H₂O and light components vaporize from the crude oil, promoting the formation of porous petroleum coke. The porous petroleum coke, as a good and stable carrier for nano-Cu-based catalysts, provides good conditions for the functioning of nano-Cu-based catalysts. In addition, CO₂ is combined with H⁺ that is generated by the dissociation of H₂O, catalyzed by nano-Cu-based catalyst, and undergo thermal reduction reaction to generate small organic molecules such as methane, methanol or formic acid.

The method provided by the present invention is a technical solution of continuous injection of CO₂ and H₂O to displace crude oil and sequestrate CO₂. CO₂ and H₂O are injected into the deep geothermal reservoir (comprising hot dry rock), where CO₂ is thermally reduced into small organic molecules such as methane, methanol and formic acid, with the assistant of H⁺ generated from H₂O vaporization in combination with uniformly distributed nano-Cu-based catalyst that supported by porous petroleum coke. Then the high-temperature CO₂, H₂O vapor and the generated small organic molecules pass through the catalyst cylinder that installed in the transfer well, during which the CO₂ thermal reduction reaction further occurs. Finally, the high-temperature CO₂, H₂O vapor and products of CO₂ reduction together carry the nano-Cu-based catalyst into the crude oil reservoir to activate and accelerate the hydrothermal cracking reaction of crude oil and the thermal reduction of CO₂ simultaneously. Among them, the products of CO₂ thermal catalytic reduction (formic acid, methanol, etc.) can play the role of surfactants to accelerate the desorption of crude oil on the rock surface, further improving the oil displacement efficiency. Moreover, the present invention makes full use of the thermal energy of deep geothermal reservoir in combination with nano-Cu-based catalysts to achieve the hydrothermal cracking reaction of crude oil and CO₂ thermal reduction reaction, so as to simultaneously enhance crude oil recovery and CO₂ sequestration, fundamentally solving the existing problems of CO₂-EOR technology.

The experimental results show that during the application of the current CO₂-EOR technology (i.e., CO₂ and H₂O were injected into the crude oil reservoir), the crude oil production gradually decreased from 560 m³/d to 350 m³/d, and then CO₂ channeling emerged, so that the crude oil production dropped sharply to 170 m³/d. During this process, the production of CO₂ increased from 200 m³/d to 320 m³/d, and CO₂ channeling occurred in May 2019, resulting in a large amount of CO₂ leakage. When the method provided by the present invention was adopted, the crude oil production rose to 620 m³/d and remained stable, and the CO₂ production decreased to 100 m³/d and remained stable.

### BRIEF DESCRIPTION OF DRAWINGS

FIG. 1 is the schematic diagram 1 of the reservoir stimulation (including liquid nitrogen fracturing; the mixed fluid injection; the hydrothermal cracking of crude oil into light crude oil and petroleum coke; and the light crude oil displacement) in the geothermal reservoir of the method of the geothermal driven CO₂ catalytic reduction for enhancing CO₂ sequestration and oil recovery provided by the present invention;

FIG. 2 is the schematic diagram 2 of the characteristics of catalyst cylinder in the wellbore of transfer well of the method of the geothermal driven CO₂ catalytic reduction for enhancing CO₂ sequestration and oil recovery provided by the present invention;

FIG. 3 is the schematic diagram 3 of the all the reaction mechanisms of the method of the geothermal driven CO₂ catalytic reduction for enhancing CO₂ sequestration and oil recovery provided by the present invention;

FIG. 4 is a comparative statistical diagram of the crude oil production and the CO₂ injection and production before and after the implementation of the method of the geothermal driven CO₂ catalytic reduction for enhancing CO₂ sequestration and oil recovery provided by the present invention.

### DETAILED DESCRIPTION

In order to further understand the present invention, the preferred embodiments of the present invention are described below in conjunction with examples, but it should be understood that these descriptions are only for further illustrating the features and advantages of the present invention rather than limiting the claims of the present invention patent.

All the raw materials of the present invention are not particularly limited in their source, which can be purchased in the market or prepared according to conventional methods well known to those skilled in the art.

The raw materials used in the present invention are not particularly limited in their purity. In the present invention, they are preferably of industrial purity or conventional purity in the field of oil recovery.

The abbreviations of all the processes of the present invention belong to the conventional abbreviations in the art, and each abbreviation is clear and definite in its relevant use field. Those skilled in the art can understand the conventional process steps according to the abbreviations.

All the noun expressions and abbreviations of the present invention belong to the conventional noun expressions and abbreviations in the art, and each noun expression and abbreviation is clear and definite in its relevant application field. Those skilled in the art can understand clearly, accurately and uniquely according to the noun expressions and abbreviations.

The present invention provides a mixed injection fluid, which, in parts by weight, comprises:

| | | |
|---|---|---|
| crude oil | 100 | parts by weight; |
| water | 8.0 to 12.0 | parts by weight; |
| proppant | 5.0 to 20.0 | parts by weight; |
| nano-Cu-based catalyst | 0.01 to 0.05 | parts by weight. |

In the present invention, the water is added in an amount of 8.0 to 12.0 parts by weight, may be 8.5 to 11.5 parts by weight, preferably 9 to 11 parts by weight, and more preferably 9.5 to 10.5 parts by weight.

In the present invention, the proppant is added in an amount of 5.0 to 20.0 parts by weight, may be 8.0 to 17 parts by weight, preferably 11 to 14 parts by weight.

In the present invention, the nano-Cu-based catalyst is added in an amount of 0.01 to 0.05 parts by weight, may be 0.015 to 0.045 parts by weight, preferably 0.02 to 0.04 parts by weight, preferably 0.025 to 0.035 parts by weight.

In the present invention, the crude oil is preferably high-viscosity crude oil rich in asphaltene and resin.

In the present invention, the viscosity of the crude oil is preferably 50 to 150 mP·s, more preferably 70 to 130 mP·s, and more preferably 90 to 110 mP·s.

In the present invention, the content of the asphaltene is preferably 8% to 25%, more preferably 11% to 22%, and more preferably 14% to 19%.

In the present invention, the content of the resin is preferably greater than 15%, more preferably greater than or equal to 18%, and more preferably greater than or equal to 20%.

In the present invention, the proppant preferably comprises one or more of quartz sand, bauxite and ceramsite, more preferably is quartz sand, bauxite or ceramsite.

In the present invention, the nano-Cu-based catalyst preferably comprises a copper catalyst and/or a copper alloy catalyst, more preferably is a copper catalyst or a copper alloy catalyst. Specifically, the copper alloy catalyst preferably comprises one or more of Cu—Sn, Cu—In and Cu—Pb.

In the present invention, the injection fluid enters the fractured fracture in the state of water-in-oil preferably as the basic liquid carrying proppant and nano-Cu-based catalyst.

In the present invention, the injection fluid is in the deep geothermal reservoir, and the nano-Cu-based catalyst preferably adheres to the porous petroleum coke carrier that formed by the hydrothermal cracking of crude oil.

The present invention provides a method for enhancing CO₂ sequestration and oil recovery, comprising the following steps:
1) arranging an injection well and a transfer well around a production well; wherein, the injection well is an injection well that is drilled through the crude oil reservoir to reach the deep geothermal reservoir, and the transfer well is a transfer well that is drilled through the crude oil reservoir to reach the deep geothermal reservoir;
wherein the perforation of the injection well in the deep geothermal reservoir is in an open state;
wherein the perforation of the transfer well in the deep geothermal reservoir is in an open state;
2) using high pressure liquid nitrogen to fracture the deep geothermal reservoir between the injection well and the transfer well;
3) injecting a mixed injection fluid into the injection well until the production of the crude oil mixture in the transfer well is equal to the injection, then stopping the injection, and placing packers in the injection well and the transfer well respectively to perform well soaking;
4) removing the packers, injecting CO₂ into the deep geothermal reservoir through the injection well to displace light crude oil components that produced by hydrothermal cracking of crude oil; producing the light crude oil components from the transfer well; and stopping the CO₂ injection until the light crude oil components are no longer produced from the transfer well;
5) opening the perforation of the transfer well at the crude oil reservoir, then placing a cylinder containing nano-Cu-based catalyst and porous nano-catalyst carrier into the wellbore of the transfer well between the crude oil reservoir and the deep geothermal reservoir, and then placing a wellbore packer in the wellbore of the transfer well above the crude oil reservoir;
6) injecting the mixture of H₂O and CO₂ into the deep geothermal reservoir through the injection well to activate CO₂ thermal reduction reaction; the water steam, CO₂ and the CO₂ thermal reduction products flowing through the cylinder containing the catalysts in the transfer wellbore, and the unreacted CO₂ being continuously reduced; and then the water steam, CO₂, the CO₂ thermal reduction products and nano-Cu-based catalyst entering the crude oil reservoir to activate the hydrothermal cracking reaction of crude oil and thermal reduction reaction of CO₂.

The above-mentioned hydrothermal cracking reaction of crude oil of the present invention can significantly reduce the viscosity of crude oil, increase the fluidity of crude oil, and enhance the oil recovery. Meanwhile, the thermal reduction reaction of CO₂ occurs to generate molecules such as methanol and formic acid, so as to achieve the permanent and stable CO₂ sequestration.

In the present invention, an injection well and a transfer well are firstly arranged around a production well; wherein, the injection well is an injection well that is drilled through the crude oil reservoir to reach the deep geothermal reservoir, and the transfer well is a transfer well that is drilled through the crude oil reservoir to reach the deep geothermal reservoir;

In the present invention, the perforation of the injection well in the deep geothermal reservoir is preferably in an open state.

In the present invention, the perforation of the transfer well in the deep geothermal reservoir is preferably in an open state.

In the present invention, the production well is preferably a production well that is drilled through and perforated the crude oil reservoir.

In the present invention, the number of the production well is preferably one or more.

In the present invention, the number of the injection well is preferably one.

In the present invention, the number of the transfer well is preferably one or more.

In the present invention, the high-pressure liquid nitrogen is used to fracture the deep geothermal reservoir between the injection well and the transfer well.

In the present invention, the deep geothermal reservoir is preferably a deep geothermal reservoir comprising hot dry rock.

In the present invention, the mixed injection fluid is injected into the injection well until the output in the transfer well is equal to that of the injection, then the injection is stopped, and packers are placed in the injection well and the transfer well respectively to perform well soaking.

In the present invention, the duration of the well soaking is preferably 20 to 30 days, more preferably 22 to 28 days, and more preferably 24 to 26 days.

In the present invention, the packers are then removed, CO₂ is injected into the deep geothermal reservoir through the injection well to displace light crude oil components that produced in the hydrothermal cracking of crude oil, then the light crude oil components are produced through the transfer well until the light crude oil components are no longer produced through the transfer well, and the CO₂ injection is stopped.

In the present invention, the perforation of the transfer well at the crude oil reservoir is opened, then a cylinder containing the nano-Cu-based catalyst and porous nano-catalyst carrier is placed in the wellbore of transfer well between crude oil reservoir and deep geothermal reservoir, and then a wellbore packer is placed in the wellbore above crude oil reservoir.

In the present invention, the cylinder is preferably a cylinder without a top cover and with a porous bottom.

In the present invention, the outer wall of the cylinder is preferably wrapped with a high temperature resistant sealing ring.

In the present invention, a porous fixing device is preferably arranged inside the cylinder.

In the present invention, the porous nano-catalyst carrier compounded with the nano-Cu-based catalyst is preferably dispersed and fixed on the porous fixing device.

In the present invention, the mass ratio of the nano-Cu-based catalyst to the porous nano-catalyst carrier is preferably 1:(10 to 20), more preferably 1:(12 to 18), more preferably 1:(14 to 16).

In the present invention, above the crude oil reservoir specifically preferably refers to a position above the crude oil reservoir close to the crude oil reservoir.

In the present invention, finally, the mixture of H₂O and CO₂ is injected into the deep geothermal reservoir through the injection well to activate CO₂ thermal reduction reaction, the water steam, CO₂ and CO₂ thermal reduction products pass through the cylinder containing the catalysts in the transfer wellbore, and the unreacted CO₂ is continuously reduced, and then the water steam, CO₂, CO₂ thermal reduction products and nano-Cu-based catalyst enter the crude oil reservoir to activate the hydrothermal cracking reaction of crude oil and thermal reduction reaction of CO₂.

In the present invention, by adjusting the operation, the proppant and/or nano-Cu-based catalyst in the mixed injection fluid in the deep geothermal reservoir preferably not enter the transfer well, or substantially not enter the transfer well.

In the present invention, the nano-Cu-based catalyst entering the crude oil reservoir is the catalyst in the catalyst cylinder, and the mixed fluid that generated from the geothermal layer can carry the catalyst in the cylinder into the crude oil reservoir. In the present invention, the catalyst cylinder can be replaced periodically.

In the present invention, in the mixture of H₂O and CO₂, the volume ratio of H₂O to CO₂ is preferably 1:(2.5 to 4), more preferably 1:(2.8 to 3.7), and more preferably 1:(3.1 to 3.4). Specifically, the above-mentioned volume ratio in the present invention refers to the volume ratio under formation pressure.

In the present invention, the injection of the mixture of H₂O and CO₂ is specifically preferably continuous injection during the oil recovery enhancement process.

In the present invention, the products of CO₂ thermal reduction reaction preferably comprise small organic molecules. Specifically, the small organic molecules preferably comprise one or more of methane, methanol and formic acid, more preferably are methane, methanol or formic acid. The products of CO₂ thermal reduction reaction obtained by the present invention can achieve the permanent and stable CO₂ sequestration. Further, the products of CO₂ thermal reduction, such as methanol, formic acid and other small organic molecules, can act as surfactants to improve the oil displacement efficiency and ultimate oil recovery.

In the present invention, the method further preferably comprises the following steps:
7) when the crude oil production gradually decreases, plugging the perforation of the transfer well in crude oil reservoir, and perforating the crude oil reservoir layer in the injection well, and continuing reverse displacement by using the mixture of H₂O and CO₂.

In the present invention, in order to better complete and refine the overall technical solution, further improve the stability of the permanent sequestration of CO₂, better improve the oil displacement efficiency, and increase the oil production, the above-mentioned method for geothermal driven CO₂ catalytic reduction for enhancing CO₂ sequestration and oil recovery can specifically comprise the following steps:
(1) Drilling an injection well through the crude oil reservoir to reach the deep geothermal reservoir (comprising hot dry rock), and opening the perforation thereof in the deep geothermal reservoir (comprising hot dry rock); correspondingly, drilling one or several transfer wells through both the crude oil reservoir and deep geothermal reservoir simultaneously, and opening the perforation thereof in the deep geothermal reservoir; drilling a production well only through the crude oil reservoir and perforating;
(2) Using high pressure liquid nitrogen to fracture the deep geothermal reservoir (comprising hot dry rock) between the injection well and the transfer well;
(3) Ultrasonically mixing crude oil, water, proppant and nano-Cu-based catalyst in a certain ratio (preferably a mass ratio of 100:10:8.0:0.01), then quickly injecting the mixture into the deep geothermal reservoir (comprising hot dry rock) that fractured by liquid nitrogen, until the production in the transfer well is equal to that of injection, and then stopping the injection, in which the crude oil should comprise more heavy components (including asphaltene and resin), and the viscosity thereof should be within 50 to 150 mP·s.

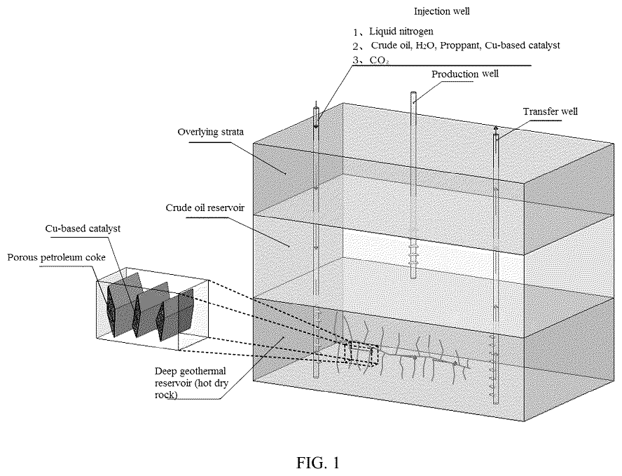

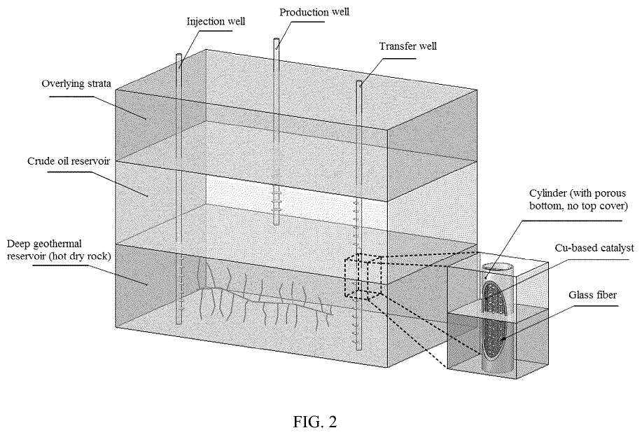

Referring to FIG. 1, FIG. 1 is the schematic diagram 1 of the reservoir stimulation (including liquid nitrogen fracturing; the mixed fluid injection; the hydrothermal cracking of crude oil into light crude oil and petroleum coke; and the light crude oil displacement) in the geothermal reservoir of the method of the geothermal driven CO₂ catalytic reduction for enhancing CO₂ sequestration and oil recovery provided by the present invention
(4) Placing packers in the injection well and the transfer well respectively, i.e., performing the well soak for 20 days;
(5) Removing the packers, injecting CO₂ into the deep geothermal reservoir (comprising hot dry rock) through the injection well to displace the light crude oil components that produced by hydrothermal cracking of crude oil, producing the light crude oil components through the transfer well, until the light crude oil components are no longer produced through the transfer well, stopping the CO₂ injection;
(6) Opening the perforation of the transfer well at the position of crude oil reservoir;
(7) Mixing the nano-Cu-based catalyst and the porous nano-catalyst carrier (mass ratio 1:20) evenly, placing the mixture in a cylinder with a diameter of 12 cm and a length of 5 m, wherein the cylinder has no top cover and has a porous bottom surface, and the outer wall thereof is wrapped with a high temperature resistant sealing ring with a thickness of about 3 cm, and the cylinder is integrally clamped in the wellbore of the transfer well between the crude oil reservoir and the geothermal reservoir (comprising hot dry rock);
Referring to FIG. 2, FIG. 2 is the schematic diagram 2 of the characteristics of catalyst cylinder in the wellbore of transfer well of the method of the geothermal driven CO₂ catalytic reduction for enhancing CO₂ sequestration and oil recovery provided by the present invention;
(8) Placing a wellbore packer in the wellbore of the transfer well above but close to the crude oil reservoir;
(9) Mixing H₂O and CO₂ in a certain ratio (1:(2.5 to 4) under formation pressure and temperature), injecting the mixture into deep geothermal reservoir (comprising hot dry rocks) through the injection well; thermally reducing CO₂ in deep geothermal reservoir (comprising hot dry rocks) and generating the small organic molecules such as methanol and formic acid, so as to achieve permanent and stable CO₂ sequestration; the mixture of H₂O vapor and CO₂ carrying CO₂ reduction products flowing through the nano-Cu-based catalyst cylinder in the transfer wellbore, in which CO₂ was also thermally reduced into the small organic molecules such as methanol and formic acid; subsequently, the mixture of H₂O vapor and CO₂ carrying CO₂ reduction products and nano-Cu-based catalyst entering into the crude oil reservoir to activate the hydrothermal cracking reaction of crude oil, which significantly reduces the viscosity of crude oil, increases the fluidity of crude oil, and enhances oil recovery; moreover, also activating the thermal catalytic reduction reaction of CO₂ and generating methanol, formic acid and other molecules, achieving permanent and stable CO₂ sequestration, wherein, specifically, the products of CO₂ thermal reduction-organic small molecules such as methanol and formic acid act as surfactants can improve the oil displacement efficiency and enhances oil recovery;

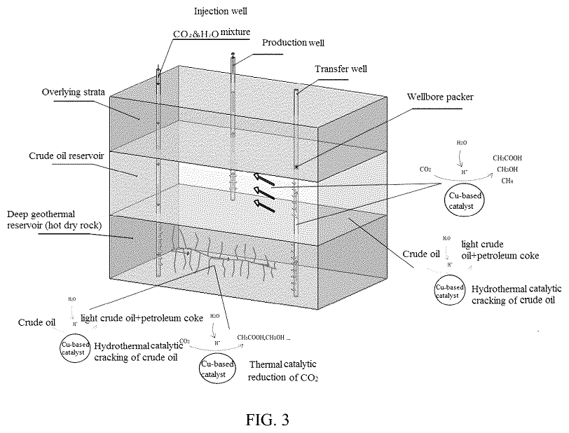

Referring to FIG. 3, FIG. 3 is the schematic diagram 3 of the all the reaction mechanisms of the method of the geothermal driven CO₂ catalytic reduction for enhancing CO₂ sequestration and oil recovery provided by the present invention.
(10) When the crude oil production gradually decreases, plugging the perforation of transfer well in crude oil reservoir, perforating the crude oil reservoir in injection well and continuing reverse displacement to further enhance oil recovery and CO₂ sequestration.

The above content of the present invention provides a method of the geothermal driven CO₂ catalytic reduction for enhancing CO₂ sequestration and oil recovery and a mixed injection fluid used. The injection fluid with a specific composition and content and the corresponding method for enhancing CO₂ sequestration and oil recovery designed by the present invention provide a technical solution of liquid nitrogen fracturing in combination with injecting the injection fluid. Since the temperature of deep geothermal reservoir, especially hot dry rock, is generally higher than 200° C., such a high temperature has severe damage to the drill unit, and conventional fracturing fluid and sand-carrying fluid are so easy to vaporize hence they cannot work normally. The temperature of liquid nitrogen is as low as −196° C. to −210° C., and the use of liquid nitrogen fracturing can effectively reduce the damage of deep geothermal reservoir to the drill unit. The most important thing is that liquid nitrogen can quickly cool the formation within a period of time, providing conditions for subsequent fluid injection, and avoiding immediate vaporization of fluid after injection. An injection fluid with a specific formulation of a mixture of crude oil and water, nano-Cu-based catalyst carried with proppant is injected into the deep geothermal reservoir (comprising hot dry rock). This is because the boiling point of crude oil is much higher than that of aqueous solution, and with the assistant of the cooling effect of liquid nitrogen, water-in-oil as the basic liquid can effectively carry proppant and nano-Cu-based catalyst into the fractured fracture. As the cooling effect of liquid nitrogen gradually decreases, the high temperature of deep geothermal reservoir (comprising hot dry rock) vaporizes H₂O and accelerates the dissociation of H₂O. The crude oil is combined with H⁺ generated by the dissociation of H₂O, catalyzed by the nano-Cu-based catalyst, and activate the hydrothermal cracking reaction to generate light crude oil and petroleum coke. During this process, H₂O and light components vaporize from the crude oil, promoting the formation of porous petroleum coke. The porous petroleum coke, as a good and stable carrier for nano-Cu-based catalysts, provides good conditions for the functioning of nano-Cu-based catalysts. In addition, CO₂ is combined with H⁺ generated by the dissociation of H₂O, catalyzed by the nano-Cu-based catalyst, and activate the thermal reduction reaction to generate small organic molecules such as methane, methanol or formic acid.

The method provided by the present invention is a technical solution of continuous injection of CO₂ and H₂O to displace oil and sequestrate CO₂. CO₂ and H₂O are injected into the deep geothermal reservoir (comprising hot dry rock), where CO₂ is thermally reduced into the small organic molecules such as methane, methanol and formic acid, with the assistant of H⁺ generated from H₂O vaporization in combination with uniformly distributed nano-Cu-based catalyst supported in porous petroleum coke. Then high-temperature CO₂, H₂O vapor and the generated small organic molecules flow through the catalyst cylinder that installed in the transfer well, during which the CO₂ thermal reduction reaction occurs continuously. Finally, the high-temperature CO₂, H₂O vapor and CO₂ reduction products together carry the nano-Cu-based catalyst into the crude oil reservoir to activate the hydrothermal cracking reaction of crude oil and the thermal catalytic reduction of CO₂ simultaneously. Among them, the products of CO₂ thermal catalytic reduction (formic acid, methanol, etc.) can play the role of surfactants to accelerate the desorption of crude oil from the rock surface and further improve the oil displacement efficiency. Moreover, the present invention makes full use of the thermal energy of deep geothermal reservoir in combination with nano-Cu-based catalysts to achieve hydrothermal cracking reaction of crude oil and CO₂ thermal reduction reaction, so as to simultaneously achieve the enhancement of the crude oil recovery and CO₂ sequestration, fundamentally solving the existing problems of CO₂-EOR technologies.

The experimental results show that during the conventional technology of injection of mixed CO₂ and H₂O was used, the crude oil production gradually decreased from 560 m³/d to 350 m³/d, and then CO₂ channeling emerged, so that the crude oil production dropped sharply to 170 m³/d. During this process, CO₂ production increased from 200 m³/d to 320 m³/d, and CO₂ channeling occurred in May 2019, resulting in a large amount of CO₂ leakage. When the method provided by the present invention was adopted, the crude oil production rose to 620 m³/d and remained stable, and the CO₂ production decreased to 100 m³/d and remained stable.

In order to further illustrate the present invention, the injection fluid and the method for enhancing CO₂ sequestration and oil recovery provided by the present invention are described in detail below with reference to the examples, but it should be understood that these examples are implemented on the premise of the technical solution of the present invention, and a detailed implementation manner and a specific operation process are given only to further illustrate the features and advantages of the present invention, not to limit the claims of the present invention, and the protection scope of the present invention is not limited to the following examples.

### Example 1

From December 2017 to June 2019, CO₂ and H₂O were mixed at a ratio of 500 m³:150 m³ (under formation pressure and temperature), and the mixture was injected into the crude oil reservoir through the injection well. The crude oil production gradually decreased from 560 m³/d to 350 m³/d, and then CO₂ channeling emerged, and the crude oil production sharply reduced to 170 m³/d. During this process, the CO₂ production increased from 200 m³/d to 320 m³/d and CO₂ channeling occurred in May 2019, resulting in a large amount of CO₂ leakage. In particular, the temperature of the injection water was stable at 250° C., which was consistent with the temperature of the target geothermal reservoir.

From June 2019 to October 2019, the technical solution in the present invention was implemented. The technical solution comprised: (1) an injection well was drilled through the geothermal reservoir and perforated; a transfer well was drilled through the crude oil reservoir into the deep geothermal reservoir around the production well and perforated both crude oil reservoir and the geothermal reservoir; (2) the high-pressure liquid nitrogen was used to fracture the deep geothermal reservoir between the injection well and transfer well; (3) the prepared injection fluid (100 parts by weight of crude oil; 10 parts by weight of water; 10 parts by weight of ceramic particle proppant; 0.025 parts by weight of nano-Cu-based catalyst) was injected into the injection well, until the production in the transfer well was equal to that of injection, the injection was stopped, the packers were placed in the injection well and the transfer well respectively, and then the well soaked for 30 days; (4) the packers were removed, then CO₂ was injected into the deep geothermal reservoir through the injection well to displace the light crude oil components that produced by hydrothermal cracking of crude oil, the light crude oil components were produced through the transfer well, until no light crude oil components were produced through the transfer well, the injection of CO₂ was stopped; (5) the perforation of the transfer well at the crude oil reservoir was opened, then the cylinder containing the nano-Cu-based catalyst and the porous nano-catalyst carrier was placed in the wellbore of transfer well between the crude oil reservoir and deep geothermal reservoir, and a wellbore packer was then placed in the wellbore of transfer well above the crude oil reservoir; (6) the mixture of CO₂ and H₂O with a ratio of 500 m 3:150 m³ (under formation pressure and temperature) was injected into the deep geothermal reservoir through the injection well, then the transfer well and the production well were connected to extract crude oil. The crude oil production rose to 620 m³/d and remained stable and the CO₂ output decreased to 100 m³/d and remained stable.

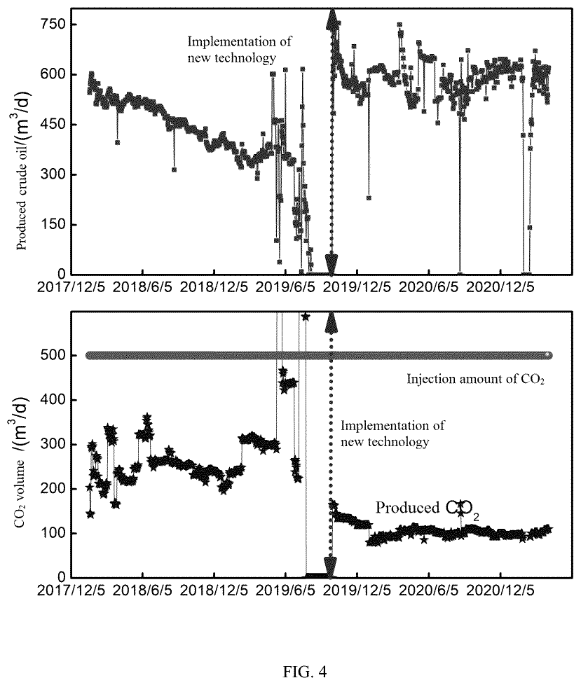

Referring to FIG. 4, FIG. 4 is a comparative statistical diagram of the crude oil production and the CO₂ injection and production before and after the implementation of the method of the geothermal driven CO₂ catalytic reduction for enhancing CO₂ sequestration and oil recovery provided by the present invention.

The method of the geothermal driven CO₂ catalytic reduction for enhancing CO₂ sequestration and oil recovery provided by the present invention has been described above in detail. Specific examples are used herein to illustrate the principles and implementations of the present invention. The descriptions of the above examples are only used to help understand the method and the core idea of the present invention, including the best manner, and to enable any person skilled in the art to practice the present invention, including making and using any devices or systems, and implementing any combined methods. It should be noted that for those skilled in the art, several improvements and modifications can also be made to the present invention without departing from the principle of the present invention, and these improvements and modifications also fall within the protection scope of the claims of the present invention. The protection scope of the present patent for invention is defined by the claims, and may include other embodiments that occur to those skilled in the art. Such other embodiments are intended to be within the scope of the claims if they have structural elements that do not differ from the literal language of the claims, or if they include equivalent structural elements with insubstantial differences from the literal language of the claims.

1. A mixed injection fluid, in parts by weight, comprising:
crude oil 100 parts by weight;
water 8.0 to 12.0 parts by weight;
proppant 5.0 to 20.0 parts by weight;
nano-Cu-based catalyst 0.01 to 0.05 parts by weight.

2. The injection fluid according to claim 1, wherein the crude oil is high-viscosity crude oil rich in asphaltene and resin;
the viscosity of the crude oil is 50 to 150 mP·s;
the content of the asphaltene is 8% to 25%;
the content of the resin is greater than 15%

3. The injection fluid according to claim 1, wherein the proppant comprises one or more of quartz sand, bauxite and ceramsite;
the nano-Cu-based catalyst comprises a copper catalyst and/or a copper alloy catalyst;
the injection fluid enters the fractured fracture in the state of water-in-oil as the basic liquid carrying proppant and nano-Cu-based catalyst;
the injection fluid is in the deep geothermal reservoir, and the nano-Cu-based catalyst adheres to the porous petroleum coke carrier formed by the hydrothermal cracking of the crude oil.

4. A method for enhancing CO₂ sequestration and oil recovery comprising the following steps:
1) arranging an injection well and a transfer well around a production well; wherein, the injection well is an injection well that is drilled through the crude oil reservoir to reach the deep geothermal reservoir, and the transfer well is a transfer well that is drilled through the crude oil reservoir to reach the deep geothermal reservoir;
wherein the perforation of the injection well in the deep geothermal reservoir is in an open state;
wherein the perforation of the transfer well in the deep geothermal reservoir is in an open state;
2) using the high-pressure liquid nitrogen to fracture the deep geothermal reservoir between the injection well and the transfer well;
3) injecting an injection fluid into the injection well until the production in the transfer well is equal to that of injection, then stopping the injection, and placing packers in the injection well and the transfer well respectively, and then performing well soaking;
4) removing the packers, injecting CO₂ into the deep geothermal reservoir through the injection well to displace light crude oil components that produced by the hydrothermal cracking of crude oil, producing the light crude oil components through the transfer well until the light crude oil components are no longer produced, and stopping the CO₂ injection;
5) opening the perforation of the transfer well at the crude oil reservoir, then placing a cylinder containing nano-Cu-based catalyst and porous nano-catalyst carrier into the wellbore of transfer well between the crude oil reservoir and deep geothermal reservoir, and placing a wellbore packer in the wellbore of the transfer well above crude oil reservoir;
6) injecting the mixture of H₂O and CO₂ into the deep geothermal reservoir through the injection well and thermally reducing CO₂; the water steam, CO₂ and CO₂ thermal reduction products flowing through the cylinder containing the catalysts in the transfer wellbore, and the unreacted CO₂ being continuously reduced; and then the water steam, CO₂, CO₂ thermal reduction products and nano-Cu-based catalyst entering the crude oil reservoir and activating the hydrothermal cracking reaction of crude oil and CO₂ thermal reduction reaction.

5. The method according to claim 4, wherein the production well is a production well that is drilled through and perforates the crude oil reservoir;
the number of the production well is one or more;
the number of the injection well is one.

6. The method according to claim 4, wherein the number of the transfer well is one or more;
the deep geothermal reservoir is a deep geothermal reservoir comprising hot dry rock;
the duration of the well soaking is 20 to 30 days.

7. The method according to claim 4, wherein the cylinder is a cylinder without a top cover and with a porous bottom;
the outer wall of the cylinder is wrapped with a high temperature resistant sealing ring;
a porous fixing device is arranged inside the cylinder;
the porous nano-catalyst carrier compounded with the nano-Cu-based catalyst is dispersed and fixed on the porous fixing device.

8. The method according to claim 4, wherein the mass ratio of the nano-Cu-based catalyst to the porous nano-catalyst carrier is 1:(10 to 20);
above the crude oil reservoir is specifically a position above the crude oil reservoir close to the crude oil reservoir;
in the mixture of H₂O and CO₂, the volume ratio of H₂O to CO₂ is 1:(2.5 to 4), and the volume ratio is the volume ratio under formation pressure and temperature.

9. The method according to claim 4, wherein the injection of the mixture of H₂O and CO₂ is specifically continuous injection during the oil recovery enhancement process;
the products of CO₂ thermal reduction reaction comprise small organic molecules;
the small organic molecules comprise one or more of methane, methanol and formic acid.

10. The method according to claim 4, wherein the method further comprises the following steps:
7) when the crude oil production gradually decreases, plugging the perforation of the transfer well in the crude oil reservoir, perforating the injection well at the crude oil reservoir, and continuing reverse displacement by using the mixture of H₂O and CO₂.
